(19) United States
(12) Patent Application Publication
(10) Pub. No.: US 2018/0038405 A1
(43) Pub. Date: Feb. 8, 2018

(54) TWIST-IN-PLACE GROMMET ASSEMBLY

(71) Applicant: ILLINOIS TOOL WORKS INC, Glenview, IL (US)

(72) Inventors: Chad M. Clark, Stamping Ground, KY (US); Ronald C. Owens, Lawrenceburg, KY (US); Jeremy R.D. Tuttle, Dearborn, MI (US)

(21) Appl. No.: 15/655,199

(22) Filed: Jul. 20, 2017

Related U.S. Application Data
(60) Provisional application No. 62/369,898, filed on Aug. 2, 2016.

(51) Int. Cl. F16B 21/02; F16B 37/04; F16B 41/00; F16B 5/02

(52) U.S. Cl. CPC F16B 21/02; F16B 5/0241; F16B 37/042; F16B 41/002

(57) ABSTRACT

A connection assembly including a grommet of hollow construction adapted to be retained within a retaining panel structure for attachment to a substructure. The grommet includes an upper collar and a lower collar disposed in spaced-apart relation. An axial bore extends through the grommet. Anti-rotation elements may be disposed between the upper and lower collars. The anti-rotation elements lock the grommet against rotational movement following insertion and rotation to a locking position within a complementary retaining panel opening. The grommet may carry variations of a compression limiter within the axial bore of the grommet and either an elongated fastener or a fastening nut may be secured in operative position with the grommet prior to shipment and installation.

### CROSS REFERENCE TO RELATED APPLICATION(S)

This non-provisional application claims the benefit of, and priority from, U.S. provisional patent application No. 62/369,898 having a filing date of Aug. 2, 2016. The contents of such prior application are hereby incorporated by reference in their entirety as if fully set forth herein.

### TECHNICAL FIELD

The present disclosure relates generally to fasteners and, more particularly, the disclosure pertains to a grommet for a connection assembly which is lockable within a panel or other support structure adapted for attachment to an underlying substructure. The grommet is installed and captured within the support panel and provides noise and vibration isolation on both sides of the structure.

### BACKGROUND

A covering structure such as a plastic engine cover or the like may be attached to an underlying substructure such as an engine block by passing elongated fasteners such as connection bolts or the like through openings in the covering structure for engagement with the substructure. In this regard, the elongated fasteners may extend either towards the substructure (i.e. away from the covering structure) or towards the covering structure (i.e. away from the substructure). It is known to use grommets of rubber or other resilient compressible material held within the openings of the covering structure for disposition in surrounding relation to the connection bolts. Such grommets are intended to prevent bolt movement and accompanying vibration noise.

As will be appreciated, in the manufacturing process, a covering structure may be produced at a location remote from the point of assembly to a substructure. In known prior designs, the fasteners or fastening nuts are not captured within the covering structure prior to being shipped. Rather, prior designs typically require an individual user to manually attach a grommet and other fastening components within the covering structure and to then attach the covering structure to the engine block or other substructure manually. During such manual assembly procedures, the typical practice has been to use “H” shaped grommets having relatively thin integral flanges at either end connected by a neck with an axial bore extending the length of the grommet. Such grommets are typically forced through a hole in the covering structure with dimensions smaller than the integral flanges and then a metal stamping or bushing is pushed into the axial bore. An elongated fastening element such a threaded bolt or the like then may project through the stamping or bushing in connecting relation between the covering structure and the sub structure.

The prior practice using traditional “H” shaped grommets provides excellent containment and vibration damping in many environments of use. However, in some instances, insertion of the traditional style grommets may be cumbersome due to the tight tolerances involved requiring the application of substantial force. This may be particularly problematic in the event that the covering structure is relatively fragile, since application of improper or excessive force may cause damage. Accordingly, an improved grommet construction and procedure of use may represent a desirable advancement over the known art.

### SUMMARY

The present disclosure provides advantages and alternatives over the prior art by providing a grommet for a connection assembly adapted for ease of installation with low insertion forces while maintaining desired sealing and vibration damping characteristics. The connection assembly includes a grommet of hollow construction including a first collar and a second collar disposed in spaced-apart relation. An axial bore extends through the grommet. Resilient tabs or ribs may be disposed between the first collar and the second collar. The resilient tabs or ribs lock the grommet against rotational movement following insertion and rotation to a locking position within a complementary retaining panel opening. The grommet may carry variations of a compression limiter within the axial bore of the grommet. Either an elongated fastener or a fastening nut may be secured in operative position with the grommet prior to shipment and installation, thereby further reducing complexity. A connection assembly consistent with the present disclosure provides damping isolation on both sides of the component being attached with noise and vibration reduction. Moreover, the subject connection may also provide substantial cost savings over previous attachment designs.

In accordance with one exemplary practice, the present disclosure provides a connection assembly including a grommet of hollow construction adapted to be retained within a non-circular retaining panel opening in a substrate for attachment to a substructure such as an engine block or the like. The connection assembly may include a grommet of hollow construction including an upper collar and a lower collar disposed in spaced-apart relation with a reduced diameter neck extending between the upper collar and the lower collar. The lower collar is non-circular having an effective length dimension greater than an effective width dimension and is configured to pass in keyed relation through a complimentary retaining panel opening. The upper collar is configured to be blocked against entry into the retaining panel opening. An axial bore extends completely through the grommet from an outer surface of the upper collar to an outer surface of the lower collar and through an interior of the neck. The grommet may further include at least one molded-in, anti-rotation element selected from the group consisting of resilient tabs and ribs disposed between the upper collar and the lower collar. The anti-rotation elements extend radially away from the axial bore in a direction transverse to the effective length dimension of the lower collar and are adapted to block the grommet against rotational movement following insertion of the lower collar and subsequent rotation of the grommet relative to the retaining panel. Anti-compression sleeve elements may also be disposed at the interior of the axial bore if desired.

Other exemplary aspects and features will become apparent upon review of the following detailed description of potentially preferred embodiments and accompanying drawings.

### BRIEF DESCRIPTION OF THE DRAWINGS

FIG. 1 is a schematic perspective view illustrating a first exemplary embodiment of a rubber grommet consistent with the present disclosure;

FIG. 2 is a schematic view illustrating an exemplary mating hole for acceptance and retention of the grommet illustrated in FIG. 1 within a cover structure;

FIG. 3 is a schematic view illustrating initial insertion of an exemplary connection assembly into a cover structure consistent with the present disclosure;

FIG. 3A is a schematic view similar to FIG. 3 wherein the connection assembly has been rotated relative to the cover structure to a locked position;

FIG. 4 is a cut-away schematic view illustrating a connection assembly consistent with the present disclosure incorporating a first compression limiting stamping insert and elongated bolt within a grommet of FIG. 1;

FIG. 5 is a cut-away schematic view illustrating a connection assembly consistent with the present disclosure incorporating a second compression limiting stamping insert and elongated bolt within a grommet of FIG. 1;

FIG. 6 is an assembled schematic view illustrating a connection assembly consistent with FIGS. 4 and 5 with a compression limiting stamping insert and elongated bolt within a grommet of FIG. 1;

FIG. 7 is a cut-away schematic view illustrating a connection assembly consistent with the present disclosure incorporating a compression limiting stamping insert and an aligned captured metal flange nut within a grommet of FIG. 1;

FIG. 8 is a schematic perspective view illustrating a second exemplary embodiment of a rubber grommet consistent with the present disclosure incorporating raised compressible ribs; and

FIG. 9 is a schematic view illustrating an exemplary mating hole for acceptance and retention of the grommet illustrated in FIG. 8 within a cover structure.

Before the embodiments of the disclosure are explained in detail, it is to be understood that the disclosure is not limited in its application to the details of construction or the arrangements of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof. Any dimensions are non-limiting and are exemplary only.

### DETAILED DESCRIPTION OF PREFERRED EMBODIMENTS

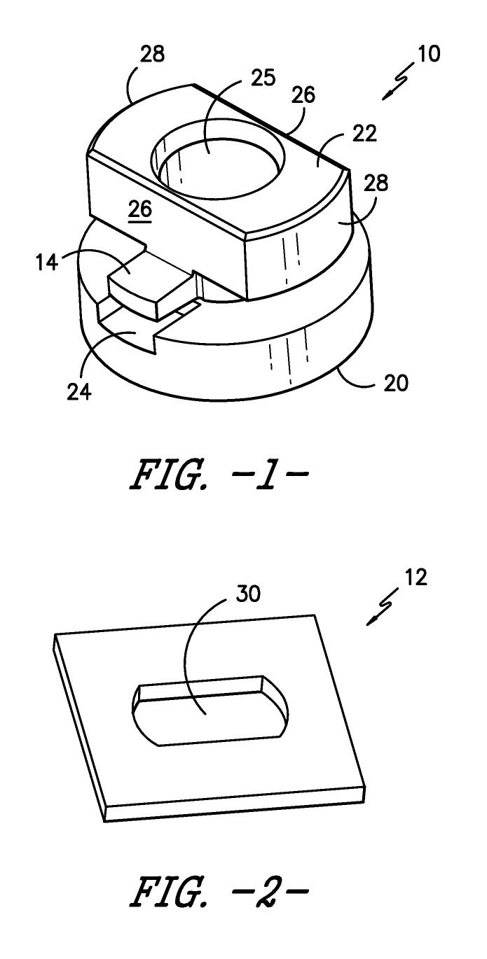

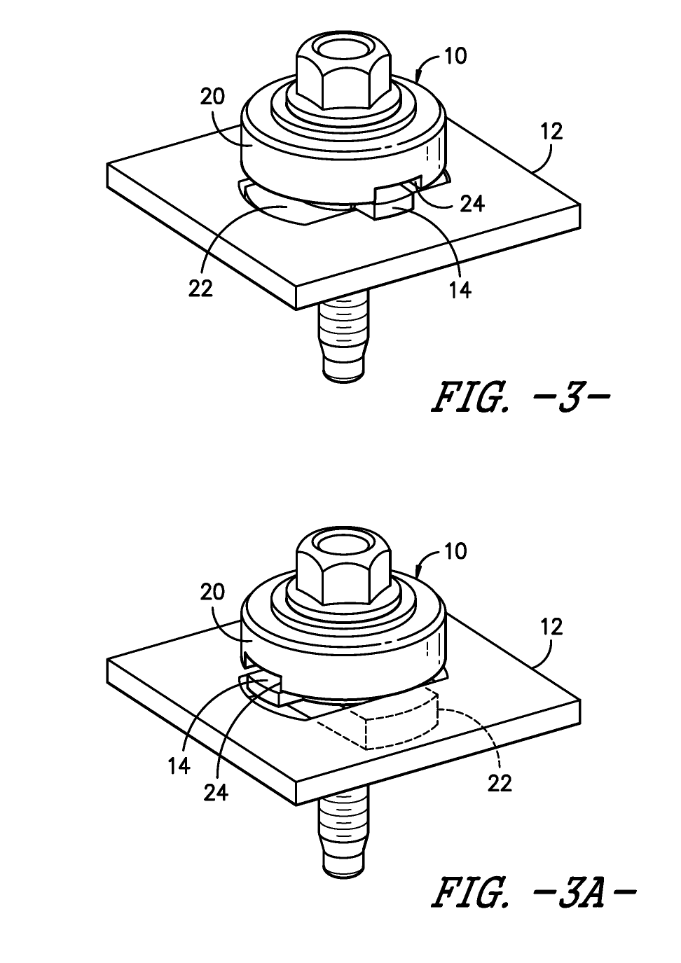

Reference will now be made to the drawings, wherein to the extent possible like reference numerals are used to designate like elements in the various views. Referring now to the drawings, FIG. 1 illustrates a first embodiment of an exemplary molded elastomeric grommet 10 that provides noise, vibration, and/or material isolation on two sides of a structure 12 (FIG. 2) such as an engine cover or the like overlying a substructure such as an engine block or the like (not shown). The grommet 10 may be formed from any suitable elastomeric material including natural and/or synthetic rubbers having a degree of compressibility and resilience suitable for sound damping. By way of example only, representative materials of construction may include NBR, SBR, EPDM, TPE, VMQ and the like as well as blends of two or more such materials if desired.

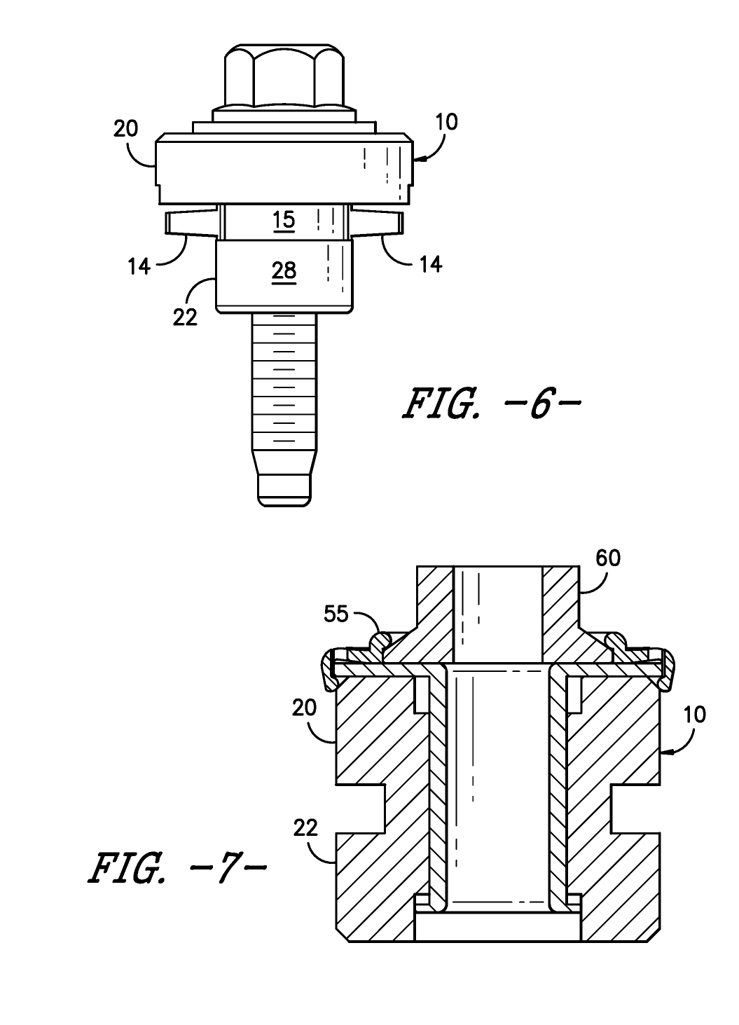

As illustrated, in the exemplary construction, the grommet 10 may include molded-in stops 14 in the form of compressible tabs positioned at a reduced diameter neck 15 (FIG. 6) between an upper collar 20 and a lower collar 22. In this regard, it is to be understood that while various spatial and directional terms, such as upper, lower and the like may be used to describe embodiments within the scope of the present disclosure, such terms are merely used with respect to the orientations of exemplary final use as illustrated in FIGS. 3 and 3A. Accordingly, the orientations may be inverted, rotated, or otherwise changed, such that an upper portion is a lower portion, and vice versa, horizontal becomes vertical, and the like.

As shown, in the exemplary embodiment of FIG. 1, depressions 24 in the form of molded-in cutouts may be disposed along an interior surface of the first collar 20 facing towards the stops 14. An axial bore 25 extends through the entirety of the grommet 10 between the upper collar 20 and lower collar 22. Thus, a bolt or other elongated fastening element can extend through the grommet 10 as illustrated in the various views.

As will be described more fully hereinafter, during initial insertion of the grommet 10 into the structure 12, the lower collar 22 may pass through a complementary thru-hole 30 in the structure 12 thereby causing the stops 14 in the form of compressible tabs to be pressed into corresponding depressions 24 upon encountering resistance at the surface of the structure 12. Upon subsequent rotation to a locking position, the stops 14 may then spring away from the depressions 24 to the position shown in FIG. 1, thereby blocking rotation reversal. In this regard, although the exemplary construction is illustrated as incorporating two stops 14 in the form of compressible tabs and two corresponding depressions 24 positioned at approximately 180 degrees from one another, it is likewise contemplated that other orientations and numbers of stops 14 and depressions 24 may be used. It is also contemplated that some or all of the depressions 24 may be eliminated if desired.

As shown, in the exemplary construction, the lower collar 22 which is inserted into the thru-hole 30 may have a shape having an effective major length dimension greater than the effective width dimension such as a rectangular or elliptical shape. By of example only, and not limitation, as best seen in FIG. 1, the upper collar may be substantially round and the lower collar 22 may have a generally lobe-shaped perimeter including a pair of opposing, substantially flat lateral sides 26 extending between a pair of opposing curved ends 28. However, other geometries may likewise be used if desired. It is also contemplated that the upper collar and lower collar may have similar shapes, but of different relative size and/or orientation to facilitate blocking withdrawal following insertion and rotation.

As best seen through joint reference to FIGS. 1-3, when the non-circular lower collar 22 is initially inserted in keyed relation through the complementary shaped thru-hole 30 in the attached structure 12 (FIG. 3), vertical pressure is applied to the grommet 10 so as to compress the stops 14 against the surface of the attached structure 12. As pressure is applied against the stops 14, they are then pushed into the opposing depressions 24. In order to lock the grommet 10 into place following the initial keyed insertion of the lower collar 22 into the thru-hole 30, the grommet 10 then may be rotated approximately ¼ turn while maintaining downward pressure.

By way of example only, and not limitation, during relative rotation between the grommet 10 and the structure 12, the lower collar 22 is caused to move from the position in FIG. 3 across the underside of the structure 12 until reaching a position as shown in FIG. 3A wherein the lower collar 22 acts to block against vertical withdrawal as it is no longer aligned with the thru-hole 30. In the blocked condition (FIG. 3A), the molded-in stops 14 simultaneously block against reverse rotation. In this regard, in the illustrated exemplary construction, the molded-in stops 14 in the form of compressible tabs may project outwardly at approximately 90 degrees to the major dimension of the lower second collar 22. Thus, a ¼ turn rotation of the grommet 10 following initial insertion will cause the stops 14 to spring away from the compressed condition within the depressions 24. That is, when reaching the final position, the molded-in stops 14 become uncompressed as they are no longer in contact with the upper surface of the structure and fall into the thru hole 16. In this position, the stops 14 act as a rotation locking mechanism for the grommet 10 with the structure 12 surrounding the neck 15.

In accordance with one exemplary practice, it may be desirable for the outer diameter of the neck 15 to substantially match the effective width dimension of the thru-hole 30 so as to maintain a tight fit relationship in the locking position. However, other arrangements can also be used if desired.

Significantly, the grommet's non-circular lower second collar 22 in conjunction with compressible stops 14 which project into a keyed thru-hole 30 in the structure 12 upon rotation to a locking position, substantially eliminates the need to radially compress the lower collar 22 during initial insertion. Accordingly, any potential for damage to the structure 12 is greatly reduced.

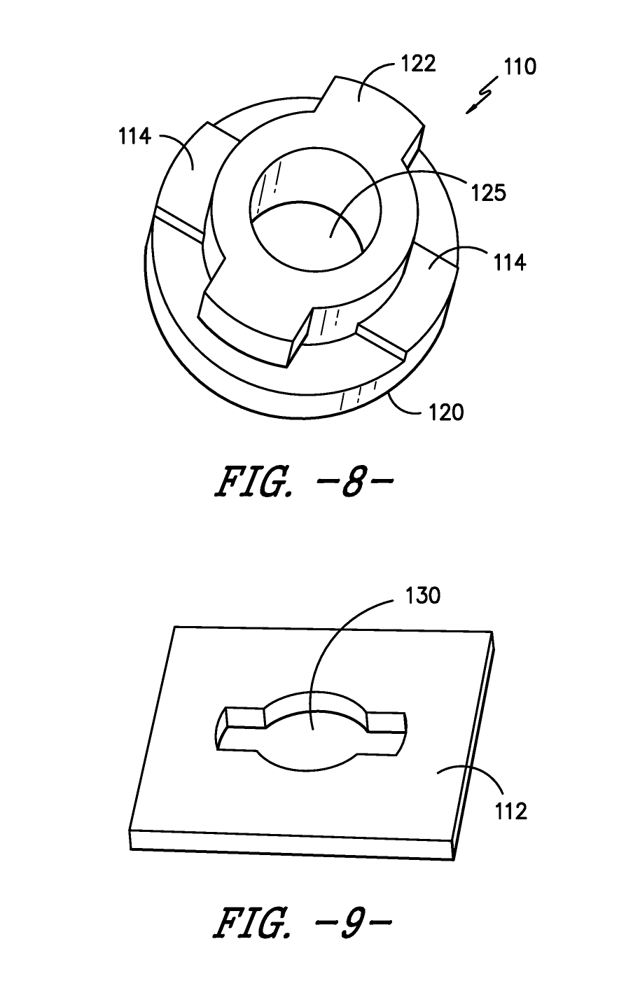

While FIG. 1 and related figures illustrate one exemplary embodiment for a grommet consistent with the present disclosure, it is also contemplated that any number of other embodiments incorporating molded-in stops may be used if desired. By way of example only, and not limitation, FIG. 8 illustrates a grommet 110 incorporating molded-in compressible stops 114 in the form of compressible raised ribs across the surface of an upper collar 120. In the illustrated exemplary construction, the stops 114 are disposed adjacent a neck portion between the upper collar 120 and a lower collar 122. As shown, the molded-in stops 114 are arranged at about 90 degrees transverse to the major dimension of lower second collar 122. An axial bore 125 extends through the entirety of the grommet 10 between upper first collar 20 and a lower second collar 22.

In use, the lower collar 122 may be inserted through a complementary thru-hole 130 (FIG. 9) in an attached structure 112. During this insertion, vertical pressure is applied to the grommet, thereby compressing the molded-in stops 114. With the pressure still applied, the grommet 110 may then be rotated approximately ¼ turn until the molded-in stops 114 fall into the thru-hole 130 and become uncompressed. In this position, the molded-in stops 114 act as a rotational blocking mechanism for the grommet 110. Thus, a ¼ turn rotation of the grommet 110 following initial insertion will cause the lower collar 122 to block against vertical withdrawal because it is no longer aligned, while the molded in stops 114 simultaneously block against reverse rotation. Of course, any number of other configurations may be used as desired.

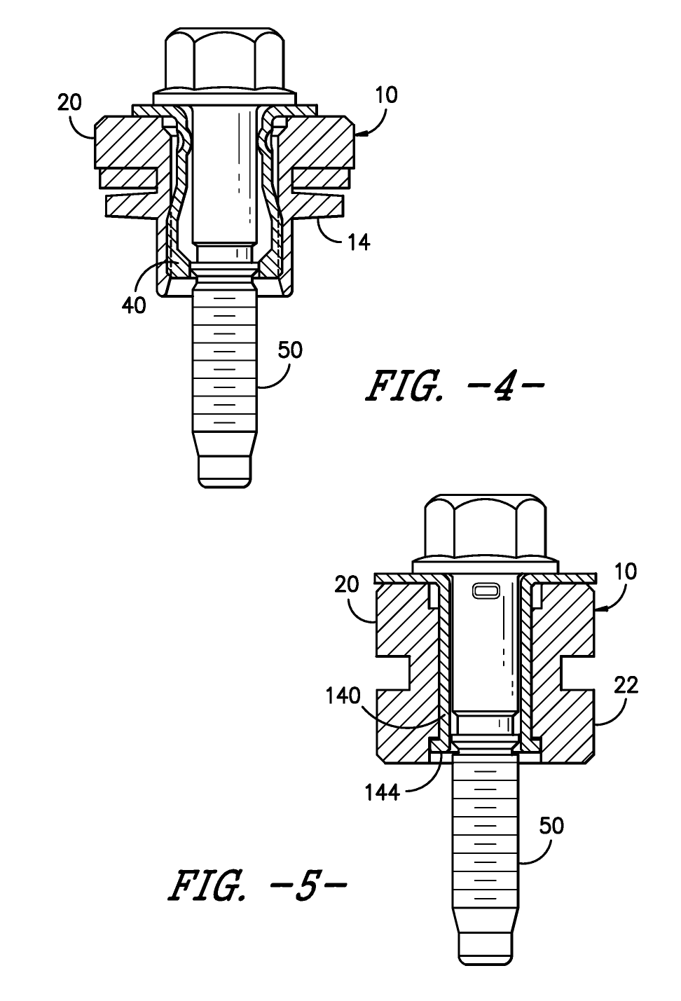

In accordance with one exemplary aspect of the present disclosure, any of the grommets 10, 110 or the like may carry different variations of a compression limiter within the axial bore 25, 125 such that the radial compression of the grommet at the neck can be limited to the desired amount on each side of a plastic structure 12, 112 such as an engine cover or the like. In one exemplary embodiment illustrated in FIG. 4, The grommet 10 may capture and carry a drawn metal stamping 40 acting as a compression limiter with an accompanying bolt 50 captured in the stamping for shipment prior to use. This option will be used in design arrangements that utilize tapped threaded holes within the underlying engine block or other substructure for the attachment points. Of course, compression limiters of non-metallic materials of sufficient strength such as composites, high impact plastics and the like may also be used if desired.

In another exemplary embodiment illustrated in FIG. 5, The grommet 10 may capture and carry a drawn metal stamping 140 acting as a compression limiter with an accompanying bolt 50 captured in the stamping. As shown, this option may include a radially outwardly projecting flared foot 144 at the bottom of the metal stamping 140 for engagement at an interior shoulder within the grommet. This design may be used to facilitate barrel clearance. As with the earlier described construction, compression limiters of non-metallic materials of sufficient strength such as composites, high impact plastics and the like may also be used if desired.

As noted previously, grommet assemblies consistent with the present disclosure also may be constructed to engage male members such as threaded studs and the like protruding upwardly away from an engine block or other substructure. By way of example only, and not limitation, in FIG. 7, the grommet 10 will capture and carry a drawn metal stamping (compression limiter) with an accompanying annular nut retainer 55 and metal flange nut 60 attached to the top surface of the drawn metal stamping. By way of example only, and not limitation, this option may be used in design arrangements that utilize threaded studs for attachment points that would require a nut for fastening. Of course, non-metallic materials of sufficient strength such as composites, high impact plastics and the like may also be used if desired.

Grommet assemblies consistent with the present disclosure represent a significant improvement over previous designs wherein an “H style” grommet had to be pushed through a hole in the component and then a metal stamping or bushing was forcibly inserted into the grommet which has been proven to be difficult and cumbersome, requiring high insertion forces and component strength. Constructions consistent with the present disclosure provide significantly lower insertion forces. Thus, such constructions may be used in applications that cannot withstand high insertion forces. Moreover, designs consistent with the present disclosure provide the option of capturing a fastener and compression limiting insert and may provide positional shift by varying the diameter and tab/rib sizes.

Of course, variations and modifications of the foregoing are within the scope of the present disclosure. The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A connection assembly including a grommet of hollow construction adapted to be retained within a non-circular retaining panel opening in a retaining panel structure, the connection assembly comprising:
an elastomeric grommet of hollow construction including an upper collar and a lower collar disposed in spaced-apart relation with a neck extending between the upper collar and the lower collar, wherein the lower collar is non-circular having an effective length dimension greater than an effective width dimension, the lower collar being configured to pass in keyed relation through the retaining panel opening and wherein the upper collar is configured to be blocked against entry into the retaining panel opening, the grommet including an axial bore extending through the grommet from an outer surface of the upper collar to an outer surface of the lower collar through an interior of the neck, the grommet further including at least one molded-in anti-rotation element selected from the group consisting of resilient tabs and ribs disposed between the upper collar and the lower collar, wherein said at least one anti-rotation element extends radially away from the axial bore in a direction transverse to the effective length dimension of the lower collar, said at least one anti-rotation element being adapted to block the grommet against rotational movement following insertion of the lower collar and subsequent rotation of the grommet relative to the retaining panel.

2. The connection assembly as recited in claim 1, wherein the grommet is of unitary molded construction.

3. The connection assembly as recited in claim 1, wherein the grommet is formed from a resilient material selected from the group consisting of natural rubber, synthetic rubber, NBR, SBR, EPDM, TPE, VMQ silicone and combinations thereof.

4. The connection assembly as recited in claim 1, wherein the upper collar is substantially round.

5. The connection assembly as recited in claim 1, wherein the upper collar has a shape substantially similar to the lower collar.

6. The connection assembly as recited in claim 1, wherein said at least one molded-in anti-rotation element comprises a plurality of flexible tabs projecting radially away from the neck.

7. The connection assembly as recited in claim 6, further comprising a plurality of molded-in depressions substantially aligned with the plurality of flexible tabs, wherein the plurality of molded-in depressions is adapted to receive the plurality of flexible tabs during rotation of the grommet relative to the substrate subsequent to insertion of the lower collar.

8. The connection assembly as recited in claim 1, wherein said at least one molded-in anti-rotation element comprises a plurality of compressible ribs disposed across a lower surface of the upper collar.

9. The connection assembly as recited in claim 1, further comprising an elongated bolt or stud extending through the grommet within the axial bore.

10. The connection assembly as recited in claim 1, further comprising a rotatable flange nut retained in axially aligned relation to the axial bore.

11. A connection assembly including a grommet of hollow construction adapted to be retained within a non-circular retaining panel opening in a retaining panel structure: the connection assembly comprising:
an elastomeric grommet of hollow construction including an upper collar and a lower collar disposed in spaced-apart relation with a neck extending between the upper collar and the lower collar, wherein the lower collar is non-circular having an effective length dimension greater than an effective width dimension, the lower collar being configured to pass in keyed relation through the retaining panel opening and wherein the upper collar is configured to be blocked against entry into the retaining panel opening, the grommet including an axial bore extending through the grommet from an outer surface of the upper collar to an outer surface of the lower collar through an interior of the neck, the grommet further including at least one molded-in anti-rotation element selected from the group consisting of resilient tabs and ribs disposed between the upper collar and the lower collar, wherein said at least one anti-rotation element extends radially away from the axial bore in a direction transverse to the effective length dimension of the lower collar, said at least one anti-rotation element being adapted to block the grommet against rotational movement following insertion of the lower collar and subsequent rotation of the grommet relative to the retaining panel; and
a compression limiter comprising a substantially rigid sleeve within the axial bore.

12. The connection assembly as recited in claim 1, wherein the grommet is formed from a resilient material selected from the group consisting of natural rubber, synthetic rubber, NBR, SBR, EPDM, TPE, VMQ silicone and combinations thereof.

13. The connection assembly as recited in claim 11, wherein the upper collar is substantially round.

14. The connection assembly as recited in claim 11, wherein the upper collar has a shape substantially similar to the lower collar.

15. The connection assembly as recited in claim 11, wherein said at least one molded-in anti-rotation element comprises a plurality of flexible tabs projecting radially away from the neck.

16. The connection assembly as recited in claim 15, further comprising a plurality of molded-in depressions substantially aligned with the plurality of flexible tabs, wherein the plurality of molded-in depressions is adapted to receive the plurality of flexible tabs during rotation of the grommet relative to the substrate subsequent to insertion of the lower collar.

17. The connection assembly as recited in claim 11 wherein said at least one molded-in anti-rotation element comprises a plurality of compressible ribs disposed across a lower surface of the upper collar.

18. The connection assembly as recited in claim 11, further comprising an elongated bolt or stud extending through the grommet within the compression limiter.

19. The connection assembly as recited in claim 11, further comprising a rotatable flange nut retained in axially aligned relation to the axial bore.

20. A connection assembly including a grommet of hollow construction adapted to be retained within a non-circular retaining panel opening in a retaining panel structure: the connection assembly comprising:
an elastomeric grommet of molded, unitary hollow construction formed from a material selected from the group consisting of NBR, SBR, EPDM, TPE, VMQ silicone and combinations thereof, the grommet including an upper collar and a lower collar disposed in spaced-apart relation with a neck extending between the upper collar and the lower collar, wherein the lower collar is non-circular having an effective length dimension greater than an effective width dimension, the lower collar being configured to pass in keyed relation through the retaining panel opening and wherein the upper collar is substantially round or of similar shape to the lower collar and configured to be blocked against entry into the retaining panel opening, the grommet including an axial bore extending through the grommet from an outer surface of the upper collar to an outer surface of the lower collar through an interior of the neck, the grommet further including a plurality of molded-in anti-rotation elements selected from the group consisting of resilient tabs and ribs disposed between the upper collar and the lower collar, wherein said plurality of molded-in anti-rotation elements extend radially away from the axial bore in a direction transverse to the effective length dimension of the lower collar, said plurality of molded-in anti-rotation elements being adapted to block the grommet against rotational movement following insertion of the lower collar and subsequent rotation of the grommet relative to the retaining panel; and
a compression limiter comprising a substantially rigid sleeve within the axial bore.
